(19) United States
(12) Patent Application Publication
(10) Pub. No.: US 2026/0204079 A1
(43) Pub. Date: Jul. 16, 2026

(54) METHOD DETECTION OF GROUPED TRAFFIC SIGN OBJECTS FOR CROWDSOURCING

(71) Applicant: GM Global Technology Operations LLC, Detroit, MI (US)

(72) Inventors: Vivek Vijaya Kumar, Shelby Township, MI (US); Mason David Gemar, Cedar Park, TX (US); Milan Kumar Biswal, Las Cruces, NM (US)

(73) Assignee: GM Global Technology Operations LLC, Detroit, MI (US)

(21) Appl. No.: 19/022,216

(22) Filed: Jan. 15, 2025

(51) Int. Cl. G06V 20/58; G06V 10/40; G06V 10/764; G06V 10/80

(52) U.S. Cl. CPC G06V 20/582; G06V 10/40; G06V 10/764; G06V 10/803; G06V 2201/10

(57) ABSTRACT

A method of detecting grouped traffic sign objects includes receiving image data from a plurality of vehicles, the image data capturing a plurality of traffic signs, and refining the image data by filtering the image data to remove unfit image frames and assigning each traffic sign captured in the image data to one or more sign groups. For each corresponding sign group of the one or more sign groups, the method also includes processing the corresponding sign group to extract, metadata associated with each of the traffic signs assigned to the corresponding sign group, infer, based on the metadata, an intent of the corresponding sign group, infer, based on the metadata, a context of each of the traffic signs assigned to the corresponding sign group, and store the corresponding sign group in a datastore.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to detecting grouped traffic sign objects for crowdsourcing. In particular, in the realm of autonomous vehicle technology, the detection and storage of traffic objects are fundamental for ensuring safe and efficient navigation. Current systems utilize advanced object recognition algorithms to identify traffic signs and other relevant objects from sensor data, including cameras, light detection and ranging (LiDAR), and radar. Once detected, these objects are classified and stored in a database as individual traffic objects. This information is then used by the vehicle's autonomous systems to make informed decisions about navigation and maneuvering. By storing each detected traffic sign as an isolated entity, the system can anticipate, manage, and respond to various traffic scenarios as the vehicle approaches the traffic sign.

Notably, co-located traffic objects may lead to ambiguities, such as where the co-located traffic objects apply to different types of vehicles (e.g., light motor vehicle, trucks). Moreover, some co-located traffic objects may be intended to support and/or enhance the co-located traffic objects (e.g., speed recommendations for road conditions), rather than directly conflict with the co-located traffic objects. This underscores the importance of developing an approach that helps to resolve conflicts that may arise when autonomous vehicles encounter multiple, potentially conflicting or complimentary traffic signs simultaneously.

### SUMMARY

One aspect of the disclosure provides a computer-implemented method that when executed on data processing hardware causes the data processing hardware to perform operations that include receiving image data from a plurality of vehicles, the image data capturing a plurality of traffic signs, and refining the image data by filtering the image data to remove unfit image frames, and assigning each traffic sign captured in the image data to one or more sign groups. For each corresponding sign group of the one or more sign groups, the operations also include processing the corresponding sign group to extract, from the corresponding sign group, metadata associated with each of the traffic signs assigned to the corresponding sign group, infer, based on the metadata, an intent of the corresponding sign group, infer, based on the metadata, a context of each of the traffic signs assigned to the corresponding sign group, and store the corresponding sign group in a datastore.

Implementations of the disclosure may include one or more of the following optional features. In some implementations, each of the traffic signs assigned to the corresponding sign group are located in proximity to one another. In some examples, the received image data is captured over two or more days. In some implementations, filtering the image data further includes identifying a plurality of image frames in the image data that capture duplicate traffic signs, and fusing the duplicate traffic signs captured in the identified image frames.

In some examples, the metadata includes one or more of semantic data, color data, positioning, location, dimension, elevation, and shape. In some implementations, the datastore includes a lookup table. In some examples, processing each of the corresponding sign group further includes identifying, based on the metadata, a dependency of the corresponding sign group. In these examples, the dependency may include one of independent or supplemental. In some implementations, the intent of the corresponding sign group includes one of information, enforcement, or caution. In some examples, the context of the corresponding sign group includes one or more of vehicle type, time of day, vehicle location, and environment.

Another aspect of the disclosure provides a system including data processing hardware and memory hardware in communication with the data processing hardware. The memory hardware stores instructions that when executed by the data processing hardware cause the data processing hardware to perform operations that include receiving image data from a plurality of vehicles, the image data capturing a plurality of traffic signs, and refining the image data by filtering the image data to remove unfit image frames, and assigning each traffic sign captured in the image data to one or more sign groups. For each corresponding sign group of the one or more sign groups, the operations also include processing the corresponding sign group to extract, from the corresponding sign group, metadata associated with each of the traffic signs assigned to the corresponding sign group, infer, based on the metadata, an intent of the corresponding sign group, infer, based on the metadata, a context of each of the traffic signs assigned to the corresponding sign group, and store the corresponding sign group in a datastore.

This aspect may include one or more of the following optional features. In some implementations, each of the traffic signs assigned to the corresponding sign group are located in proximity to one another. In some examples, the received image data is captured over two or more days. In some implementations, filtering the image data further includes identifying a plurality of image frames in the image data that capture duplicate traffic signs, and fusing the duplicate traffic signs captured in the identified image frames.

In some examples, the metadata includes one or more of semantic data, color data, positioning, location, dimension, elevation, and shape. In some implementations, the datastore includes a lookup table. In some examples, processing each of the corresponding sign group further includes identifying, based on the metadata, a dependency of the corresponding sign group. In some implementations, the intent of the corresponding sign group includes one of information, enforcement, or caution. In some examples, the context of the corresponding sign group includes one or more of vehicle type, time of day, vehicle location, and environment. Another aspect of the disclosure provides a computer-implemented method that when executed on data processing hardware causes the data processing hardware to perform operations that include Identifying an approaching sign group, the sign group including a plurality of traffic signs, and receiving an intent of the sign group and a context of the sign group. The operations also include receiving a vehicle context of a vehicle, disambiguating, using the intent of the sign group and the context of the sign group, the sign group to identify a respective traffic sign of the plurality of traffic signs that corresponds to the vehicle context of the vehicle, and communicating the respective traffic sign of the plurality of traffic signs to a vehicle control of the vehicle.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is a schematic view of an example system for detecting grouped traffic sign objects for crowdsourcing.

FIG. 2 is a schematic view of example components of the system of FIG. 1.

FIG. 3 is a schematic view of example components of the system of FIG. 1.

FIG. 4 is an example datastore of the example system of FIG. 1.

FIGS. 5A-5C are example sign groups of the example datastore of FIG. 4.

FIG. 6 is a flowchart of an example arrangement of operations for a method for detecting grouped traffic sign objects for crowdsourcing.

FIG. 7 is a flowchart of an example arrangement of operations for a method of detecting grouped traffic sign objects for crowdsourcing.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

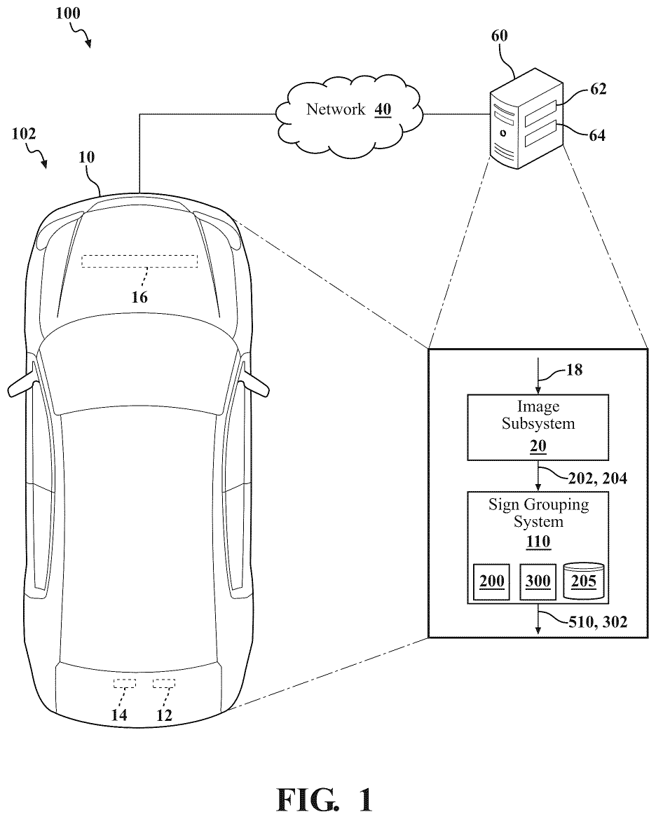

Referring to FIG. 1, in some implementations, a system 100 includes a vehicle 10 in communication with a remote system 60 via a network 40. The network 40 may include a wireless local area network (WLAN) that facilitates communication and interoperability between the vehicle 10 and the remote system 60 within an environment of the vehicle 10. Thus, the network 40 can include Wireless Fidelity (WiFi®) (e.g., IEEE 802.11), Low-Rate Wireless Personal Area Networks (e.g., IEEE 802.15.4), worldwide interoperability for microwave access (WiMAX), 3G, 4G, Long Term Evolution (LTE), 5G, digital subscriber line (DSL), Bluetooth®, Near Field Communication (NFC), or any other wireless standards, or Ethernet (e.g., IEEE 802.3). The system 100 may additionally include one or more access points (AP) (not shown) configured to facilitate wireless communication between the vehicle 10 and the remote system 60.

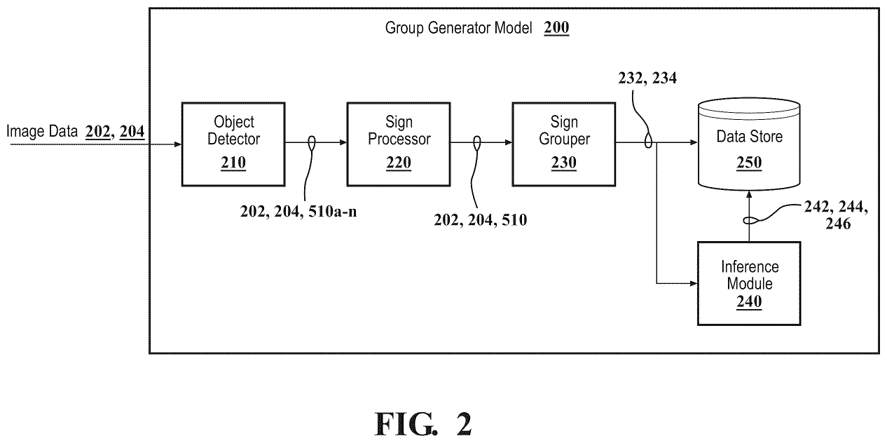

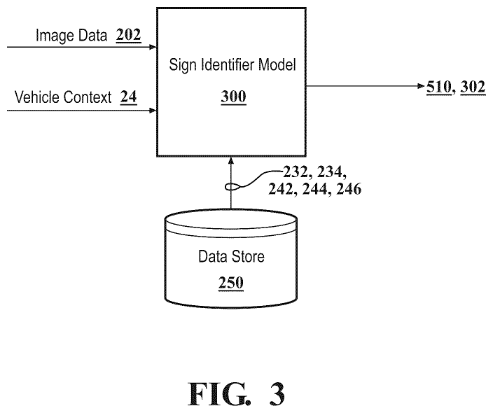

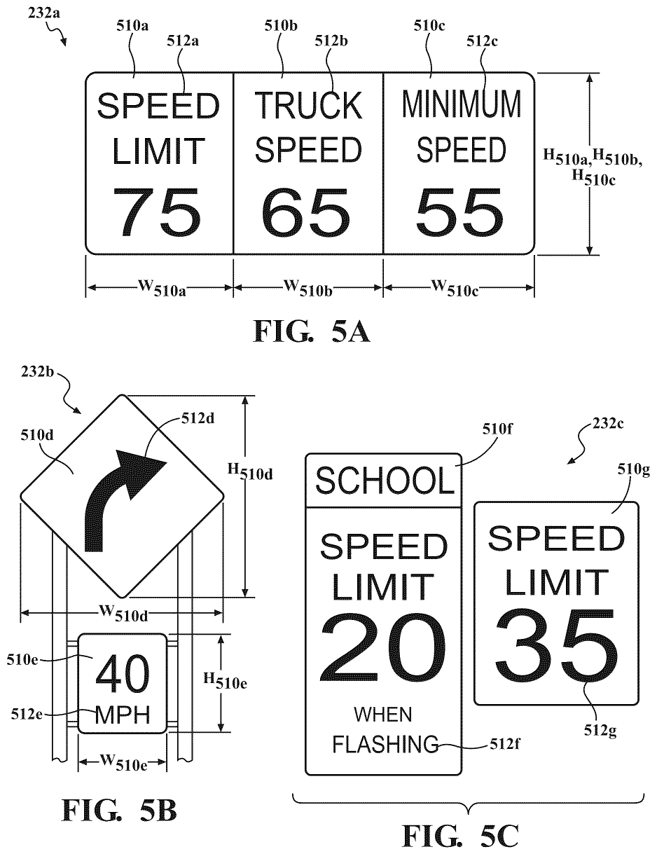

As shown, the vehicle 10 and/or the remote system 60 execute a sign grouping system 110 that executes a group generator model 200 (FIG. 2) and a sign identifier model 300 (FIG. 3). The group generator model 200 is configured to receive image data 202 from a plurality of vehicles 10 (including the vehicle 10), identify traffic signs 510 (FIGS. 5A-5C) that are co-located, and group the traffic signs 510 into a sign group 232 that is stored in a centralized datastore 250 (FIG. 2). Notably, and as will be described in further detail below, by sorting the co-located traffic signs 510 into respective sign groups 232, metadata 234 extracted from the co-located traffic signs 510 in the sign group 232 may be used to meaningfully disambiguate conflicting or complimentary traffic signs 510 when vehicles 10 encounter the sign group 232 of traffic signs 510 in the future. For instance, when a vehicle 10 approaches a sign group 232, the sign identifier model 300 may determine, based on the metadata 234 of the sign group 232, whether one or more of the co-located traffic signs 510 applies to the vehicle 10, and generate instructions for the vehicle 10 to proceed in accordance with the applicable traffic signs 510.

In the example shown, the sign grouping system 110 is implemented within the vehicle 10. However, the sign grouping system 110 may be implemented in any other propulsion system, such as, without limitation, motorcycles, trucks, off-road vehicles, bicycles, farm equipment, trains, aircraft, and the like. The vehicle 10 includes data processing hardware 12 and memory hardware 14 storing instructions that when executed on the data processing hardware 12 cause the data processing hardware 12 to perform operations. Additionally, while the sign grouping system 110 is described as being implemented by the data processing hardware 12 and memory hardware 12 of the vehicle 10, it can be implemented on other computing devices (e.g., computing devices in communication with the vehicle 10), such as, without limitation, a smart phone, tablet, smart display, desktop/laptop, smart watch, smart appliance, or smart glasses/headset.

As shown in FIGS. 1 and 2, the vehicle 10 is configured to receive sensor data 18 detected/captured by a sensor system 16. The sensor system 16 may include one or more cameras, a forward collision mitigation system, radio detection and ranging (RADAR), light detection and ranging (LiDAR) capable of capturing image data, and other external sensors of the vehicle 10. While the sensor system 16 shown in FIG. 1 is disposed on a front side of the vehicle 10, it should be appreciated that the sensor system 16 may include sensors located throughout the vehicle 10. For example, the sensor system 16 may provide 360-degree surround sensing of an environment 102 of the vehicle 10.

The system 100 may further include an image subsystem 20 for extracting image data (e.g., pixels) from images capturing the environment 102 of the vehicle 10 to generate the image data 202 of the environment 100. For instance, the image subsystem 20 may continuously receive sensor data 18 including images captured by the sensor system 16 and convert the received sensor data 18 into image data 202 including one or more image frames 204. Here, each image frame 204 may capture one or more traffic signs 510 within the environment 102 and within proximity to the vehicle 10. In some instances, the image subsystem 20 additionally converts the image frames 204 of the image data 202 into semantic data.

The remote system 60 (e.g., server, cloud computing environment) also includes data processing hardware 62 and memory hardware 64 storing instructions that when executed on the data processing hardware 62 cause the data processing hardware 62 to perform operations. In some examples, execution of the sign grouping system 110 is shared across the vehicle 10 and the remote system 60. As described in greater detail with respect to FIGS. 1-5C, the sign grouping system 110 executing on the vehicle 10 and/or the remote system 60 executes the group generator model 200 and the sign identifier model 300. As will become apparent, the group generator model 200 and the sign identifier model 300 cooperate to leverage crowdsourced vehicle data to detect co-located traffic signs 510, create sign groups 232 associating the co-located traffic signs 510 together, and use these sign groups to meaningfully disambiguate the co-located traffic signs 510 when vehicles 10 encounter the sign group 232 in the future. To leverage crowdsourcing, the sign grouping system 110 receives image data 202 from one or more vehicles 10 in the system 100 and/or one or more passes by the same vehicle 10 in the system 100 to detect the co-located traffic signs 510. In other words, the image data 202 may be captured over one or more days, by one or more vehicles 10. Optionally, the same vehicle 10 may capture image data 202 of the same co-located signs 510 over multiple passes in a single day or over several days.

With continued reference to FIGS. 1 and 2, the group generator model 200 includes an object detector 210, a sign processor 220, a sign grouper 230, and an inference module 240. The group generator model 200 further has access to a data store 240 stored on the memory hardware 14, 64. The data store 250 stores the sign groups 232 generated by the group generator model 200. As the vehicles 10 in the system 100 report/transmit the image data 202 to the group generator model 200, the group generator model 200 processes the image data 202. In particular, as shown in FIG. 2, the object detector 210 receives, as input, the image data 202 including one or more image frames 204 capturing the traffic signs 510 and performs object detection on the one or more image frames 204 to extract information and/or identify the one or more traffic signs 510. For example, the object detector 210 performs one or more object recognition techniques (e.g., object classification, object recognition, etc.) to identify the one or more traffic signs 510 in image frames 204 of the image data 202. As noted above, the object detector 210 may aggregate the image data 202 as it is collected from multiple vehicles 10 over multiple days and/or passes.

Thereafter, the sign processor 220 receives, as input, the image data 202 including the one or more image frames 204 and refines the image data 202 to generate, as output, the refined image data 202. For instance, the sign processor 220 filters the image data 202 to remove unfit image frames 204 from the image data 202. As used herein, unfit image frames 204 may generally refer to image frames 204 where corresponding global positioning system (GPS) data indicates that the image frame 204 suffers from a position error and/or where the image quality of the image frame 204 makes it unsuitable for further processing by the group generator model 200. The sign processor 220 may further refine the image data 202 by performing data clustering and de-duplication. Here, the sign processor 220 may identify one or more image frames 204 in the image data 202 reported by one or more vehicles 10 and perform clustering to group two or more image frames 204 of the image data 202 that contain the same traffic sign 510. The sign processor 220 may then detect duplicate clusters of grouped image data 202 and fuse the image data 202 together. In other words, the sign processor 220 may identify a plurality of image frames 204 in the aggregated image data 202 that capture duplicate (i.e., the same) traffic signs 510, and fuse the image data 202 for the duplicate traffic signs 510. Additionally or alternatively, the sign processor 220 identifies false detections (e.g., where a traffic sign 510 is incorrectly identified as present in the image data 202), and filters out any image frames 204 that falsely detect a traffic sign 510.

The sign grouper 230 receives the refined image data 202 from the sign processor 220 and assigns each traffic sign 510 detected in the image data 202 to one or more sign groups 232. The sign grouper 230 further processes the image data 202 to extract metadata 234 associated with each traffic sign 510. For instance, the metadata 234 may include one or more of the semantic data (i.e., text and/or characters) of the traffic sign 510, color data (e.g., red, orange, yellow, black and white, etc.) of the traffic sign 510, positioning (i.e., heading) of the traffic sign 510, the location of the traffic sign 510, the dimensions (e.g., height, width) of the traffic sign 510, the elevation at which the traffic sign 510 is mounted, and the shape of the traffic sign 510. The sign grouper 230 may assign one or more traffic signs 510 to a particular sign group 232 when the metadata 234 of each of the traffic signs 510 indicates that the traffic signs 510 are located in proximity to one another. Additionally or alternatively, the traffic signs 510 may be assigned to a particular sign group 232 when their respective metadata 234 indicates that the traffic signs 510 are co-located and share a same positioning and/or elevation height.

The sign grouper 230 may, for each assignment of a traffic sign 510, calculate a confidence that the sign 510 belongs in a particular sign group 232. For example, the sign grouper 230 may identify, based on the metadata 234, confidence factors including one or more of the number of vehicles 10 that observed the traffic sign 510, the number of passes the traffic sign 510 was observed, the number of image frames 204 from the respective sensor systems 16 of the vehicles 10 in the system 100, the amount of time between detections of the traffic sign 510, the standard deviation in the position of the traffic sign 510, the standard deviation in the heading of the traffic sign 510, and the standard deviation in the elevation of the traffic sign 510. The sign grouper 230 may then assign the traffic sign 510 to the particular sign group 232 when the confidence factors exceed a confidence threshold indicating that the traffic sign 510 should be grouped with the other traffic signs 510 in the particular sign group 232. In some instances, the sign grouper 230 may assign one or more traffic signs 510 to a particular sign group 232 based on semantic data derived from the respective metadata 234 (e.g., color, relative location, relative elevation, etc.) of each traffic sign 510.

In addition to grouping the co-located traffic signs 510 into one or more sign groups 232, the sign grouper 230 infers, based on the metadata 234 of each of the traffic signs 510 in a corresponding sign group 232, an intent 242 of the corresponding sign group 232. The intent 242 of the sign group 232 may include one or more of information (e.g., parking zone, high-occupancy vehicle (HOV) lane, etc.), enforcement (e.g., speed limits, handicapped parking, no parking, stop sign, etc.), and caution (e.g., slippery road, sharp curve, steep slope, etc.). In other words, the intent 242 of the sign group 232 may refer to the type of signs assigned to the sign group 232. In some cases, the sign grouper 230 may additionally infer the intent 242 of a particular sign group 232 based on transportation regulations and guidance on traffic signs that correspond to the particular region in which the vehicle 10 is traveling.

Thereafter, the sign grouper 230 infers, based on the metadata 234, a respective context 244 of each traffic sign 510 in the corresponding sign group 232. That is, the sign grouper 230 infers a single intent 242 for the sign group 232 as a whole, as well as an individual context 244 for each traffic sign 510 in the sign group 232. The context 242 may include one or more of a vehicle type (e.g. light motor vehicle, truck, bicycle, etc.), a time of day (e.g., school hours, after 11:00 pm, etc.), a vehicle location (e.g., lane position), a vehicle direction, and an environment (e.g., weather conditions, road conditions, etc.). In other words, the context 242 may refer to what each traffic sign 510 in the corresponding sign group 232 intends to communicate to vehicles 10 and/or how to determine which of the traffic signs 510 in the sign group 232 is applicable to a particular vehicle 10, whether based on the time of day, the type of vehicle 10, or the particular environmental conditions present when the vehicle 10 encounters the sign group 232.

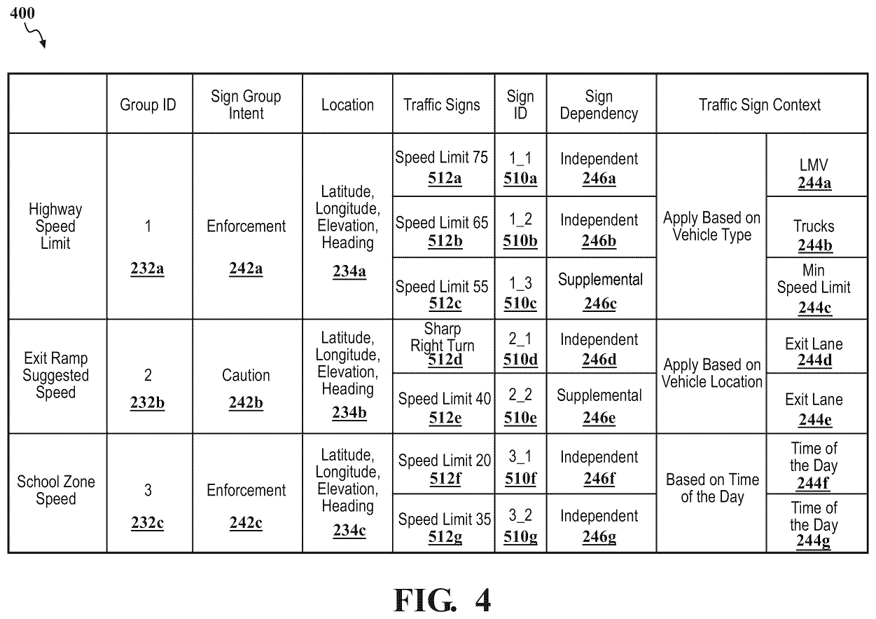

In some instances, the sign grouper 230 additionally identifies, based on the metadata 234 of each traffic sign 510 in the sign group 232, a dependency 246 of each traffic sign 510. As used herein, a dependency 246 of a traffic sign 510 refers to whether the particular traffic sign 510 is either treated independently (i.e., conflicts with) the other traffic signs 510 in its corresponding sign group 232, or is supplemental (i.e., complimentary to) the other traffic signs 510 in its corresponding sign group 232. For instance, a traffic sign 510 may be identified as having an independent dependency 246 when the traffic sign 510 does not relate to any other traffic sign 510 in the sign group 232. In contrast, a traffic sign 510 may be identified as having a supplemental dependency 246 when the traffic sign 510 enhances and/or further details another traffic sign 510 in the sign group 232. The sign grouper 230 may further, for each sign group 232, associate the intent 242, the corresponding contexts 244 of each traffic sign 510, and, where applicable, the corresponding dependencies 246 of each traffic sign 510 with the sign group 232 and store the corresponding sign group 232 in the datastore 250. In some instances, the datastore 250 includes a lookup table 400 (FIG. 4) that stores each sign group 232 and its corresponding intent 242, contexts 244, and dependencies 246 as a record in the lookup table 400.

Referring to FIGS. 4-5C, example sign groups 232a-232c generated by the sign grouper 230 are shown each including two or more traffic signs 510a-510g. The corresponding lookup table 400 storing each record generated by the group generator model 200 for each of the sign groups 232a-232c are also shown in FIG. 4. With particular reference to FIGS. 4 and 5A, the sign grouper 230 may assign the co-located traffic signs 510a-510c to a sign group 232a (i.e., group ID 1). Here, the sign grouper 230 may assign each of the traffic signs 510a-510c to the sign group 232a based on the respective metadata 234a-234c for the co-located traffic signs 510a-510c. The metadata 234a-234c may include the respective height H₅₁₀ₐ-H_{510c} of each of the traffic signs 510a-510c, the respective width W₅₁₀ₐ-W_{510c} of each of the traffic signs 510a-510c, and the graphical elements 512a-512c displayed on each of the traffic signs 510a-510c. The sign grouper 230 may identify that, based on the metadata 234a-234c, each of the traffic signs 510a-510c have the same respective width W₅₁₀ₐ-W_{510c} and the same respective height H₅₁₀ₐ-H_{510c}. Based on the common dimensions identified in the metadata 234a-234c, the sign grouper 230 may determine that the signs 510a-510c belong in the same sign group 232a. Further, the sign grouper 230 may identify that the graphical elements 512a of the traffic sign 510a include “speed limit 75,” the graphical elements 512b of the traffic sign 510b include “truck speed 65,” and the graphical elements 512c of the traffic sign 510c include “minimum speed 55.” Based on this metadata 234a-234c, the sign grouper 230 infers, as shown in FIG. 4, that the sign group 232a includes a corresponding intent 242a of enforcement (i.e., the speed limit). Further, the sign grouper 230 may store in the lookup table 400, the location metadata 234a, and the graphical elements 512a-512c of the traffic signs 510a-510c.

The sign grouper 230 may further determine that the traffic sign 510a and the traffic sign 510b have independent dependencies 246a, 246b, while the traffic sign 510c has a supplemental dependency 246c that enhances/applies to the sign group 232a as a whole. These dependencies 246a-246c are also stored in the lookup table 400 with the record of the sign group 232a. Finally, the sign grouper 230 infers, based on the metadata 234a-234c (i.e., via the graphical elements 512a-512c) the particular context 244a-244c associated with each traffic sign 510a-510c. As shown, the traffic sign contexts 244a-244c are applied based on the type of vehicle 10 that is approaching the sign group 232a. In particular, the context 244a associated with the traffic sign 510a is applied when the vehicle 10 is a light motor vehicle and communicates (via the graphical elements 512a) that a light motor vehicle 10 that encounters the sign group 232a should adhere to the speed limit of 75 miles per hour (mph). Similarly, the context 244b associated with the traffic sign 510b is applied when the vehicle 10 is a truck, and communicates (via the graphical elements 512b) that a truck type of vehicle 10 that encounters the sign group 232b should adhere to the speed limit of 65 mph. Notably, because the context 244c associated with the traffic sign 510c is applied to all vehicles 10 (i.e., has a supplemental dependency 246c), it communicates (via the graphical elements 512c) that all vehicles 10, regardless of type, that encounter the sign group 232a should adhere to a minimum speed limit of 55 mph.

Referring now to FIGS. 4 and 5B, the sign grouper 230 may assign the co-located traffic signs 510d, 510e to a sign group 232b (i.e., group ID 2). Here, the sign grouper 230 may assign each of the traffic signs 510d, 510e to the sign group 232b based on the respective metadata 234d, 244e for the co-located traffic signs 510d, 510e. The metadata 234d, 234e may include the respective height H_{510d}, H₅₁₀ₑ of each of the traffic signs 510d, 510e, the respective width W_{510d}, W₅₁₀ₑ of each of the traffic signs 510d, 510e, and the graphical elements 512d, 512e displayed on each of the traffic signs 510d, 510e. While the sign grouper 230 may identify that, based on the metadata 234d, 234e, each of the traffic signs 510d, 510e have different shapes, as well as different dimensions based on the different widths W_{510d}, W₅₁₀ₑ and the different heights H_{510d}, H₅₁₀ₑ, the sign grouper 230 may further identify that the traffic signs 510d, 510e are mounted to the same post, and accordingly assign the signs 510d, 510e to the same sign group 232b. Further, the sign grouper 230 may identify that the graphical elements 512d of the traffic sign 510d include a right curve arrow, while the graphical elements 512e of the traffic sign 510e include “40 mph.” Based on this metadata 234d, 234e, the sign grouper 230 infers, as shown in FIG. 4, that the sign group 232b includes a corresponding intent 242b of caution (i.e., to slow down on a right curve). Further, the sign grouper 230 may store, in the lookup table 400, the location metadata 234d, and the graphical elements 512d, 512e of the traffic signs 510d, 510e.

The sign grouper 230 may further determine that the traffic sign 510d has an independent dependency 246d, while the traffic sign 510e has a supplemental dependency 246e meant to supplement the traffic sign 510d. For instance, the sign grouper 230 interprets the semantic metadata 234e of the traffic sign 510d and determines that the traffic sign 510d is providing additional guidance to the traffic sign 510e. Here, the sign grouper 230 may identify that the traffic signs 510d, 510e share a same color schema (e.g., black text/symbols on a yellow background), indicating that the traffic signs 510d, 510e both indicate caution and should be interpreted together. These dependencies 246d, 246e are also stored in the lookup table 400 with the record of the sign group 232b. Finally, the sign grouper 230 infers, based on the metadata 234d, 234e (i.e., via the graphical elements 512d, 512e) the particular context 244d, 244e associated with each traffic sign 510d, 510e. As shown, the traffic sign contexts 244d, 244e are applied based on the location of the vehicle 10 that is approaching the sign group 232b. In particular, the contexts 244d, 244e associated with the traffic signs 510d, 510e are applied when the vehicle 10 is in an exit ramp lane, and cautions (via the graphical elements 512d, 512e) any vehicle 10 that encounters the sign group 232b to lower its speed to a recommended 40 mph while driving along the right curved exit ramp.

Referring now to FIGS. 4 and 5C, the sign grouper 230 may assign the co-located traffic signs 510f, 510g to a sign group 232c (i.e., group ID 3). Here, the sign grouper 230 may assign each of the traffic signs 510f, 510g to the sign group 232c based on the respective metadata 234f, 244g for the co-located traffic signs 510f, 510g. The metadata 234f, 234g may include the graphical elements 512f, 512g displayed on each of the traffic signs 510f, 510g. While processing the metadata 234f, 234g of the traffic signs 510f, 510, the sign grouper 230 identifies that the graphical elements 512f of the traffic sign 510f include “school speed limit 20 when flashing,” and the graphical elements 512g of the traffic sign 510g include “speed limit 35.” Thereafter, the sign grouper 230 may perform semantic interpretation and infer, as shown in FIG. 4, that the sign group 232c includes a corresponding intent 242c of enforcement (i.e., the speed limit). Further, the sign grouper 230 may store, in the lookup table 400, the location metadata 234c, and the graphical elements 512f, 512g of the traffic signs 510g, 510f.

The sign grouper 230 may further determine that the traffic sign 510f and the traffic sign 510g have independent dependencies 246f, 246g such that neither of the traffic sings 510f, 510g apply at the same time. These dependencies 246f, 246g are also stored in the lookup table 400 with the record of the sign group 232c. Finally, the sign grouper 230 infers, based on the metadata 234f, 234g (i.e., via the graphical elements 512f, 512g) the particular context 244f, 244g associated with each traffic sign 510f, 510g. As shown, the traffic sign contexts 244f, 244g are applied based on the time of day that the vehicle 10 is approaching the sign group 232c. In particular, the context 244f associated with the traffic sign 510f is applied when the vehicle 10 approaches the sign group 232c during school hours (e.g. when the traffic sign 510f includes a flashing beacon from 7:00-8:20 am and 3:00-4:20 pm), and communicates (via the graphical elements 512f) that the approaching vehicle 10 should adhere to the speed limit of 20 mph. Similarly, the context 244g associated with the traffic sign 510g is applied when the vehicle 10 approaches the sign group 232c outside of school hours and/or the beacon is not flashing, and communicates (via the graphical elements 512g) that the approaching vehicle 10 may adhere to the speed limit of 35 mph.

Referring now to FIGS. 1 and 3, and as noted above, the sign grouping system 110 further includes the sign identifier 300 which is in communication with the datastore 250 storing the records of the sign groups 232 and their respective associated metadata 234, intent 242, contexts 244, and dependencies 246. The sign identifier 300 may continually receive the image data 202 capturing the environment 102 of the vehicle 10, as well as a vehicle context 24 of the vehicle 10. For instance, the vehicle context 24 may include one or more of a type (i.e., light motor vehicle, truck, etc.) of the vehicle 10, a speed of the vehicle 10, a trajectory of the vehicle 10, a location of the vehicle 10, a time of the day, weather conditions of the environment 102 of the vehicle 10, a distance between the vehicle 10 and to particular sign groups 232, an elevation of the vehicle, a heading of the vehicle 10, and a lane (i.e., position) of the vehicle 10. As the vehicle 10 drives along a roadway, it receives the image data 202 and the vehicle context 24 identifies whether the vehicle 10 is approaching a sign group 232 of co-located signs 510. Here, the sign identifier model 300 may determine, based on the vehicle context 24, whether the approaching sign group 232 will apply to the vehicle 10, and whether the sign group 232 includes a plurality of traffic sings 510 that may be ambiguous.

The sign identifier model 300 may query the datastore 250 to determine whether it already contains a sign group 232 for the approaching signs and, when the datastore 250 contains the corresponding information for the approaching sign group 232, it returns the metadata 234, intent 242, contexts 244, and dependencies 246 of the sign group 232 to the sign identifier model 300. The sign identifier model 300 then use the metadata 234 including the intent 242 and the contexts 244 of the sign group 232 to disambiguate the sign group 232 and identify which traffic sign 510 of the plurality of traffic signs 510 in the sign group 232 correspond to the vehicle context 24 of the vehicle 10. Thereafter, the sign identifier may communicate the respective traffic sign 510 that corresponds to the vehicle context 24 to a vehicle control (e.g., steering, speed, braking) of the vehicle 10.

In implementations where the datastore 250 does not include a record of the approaching sign group 232 identified by a vehicle 10, the sign grouping system 110 may generate an on-the-fly record of the approaching sign group 232. For instance, the sign grouping system 110 may infer/extrapolate the intent 242 of the approaching sign group 232 based on similar sign groups 232 stored in the datastore 250. The sign grouping system 110 may then flag the on-the-fly record of the approaching sign group 232 to request verification of the intent 242 of the sign group 232 when a number of observations (e.g., via other vehicles 10 and/or multiple passes) reaches a verification threshold. Once the verification threshold is met, the on-the-fly record of the sign group 232 may be added to the lookup table 400 stored in the datastore 250 for further passes by vehicles 10. Optionally, on-the-fly records of sign groups 232 may be manually reviewed to confirm accordance with traffic control policy before being added to the lookup table 400.

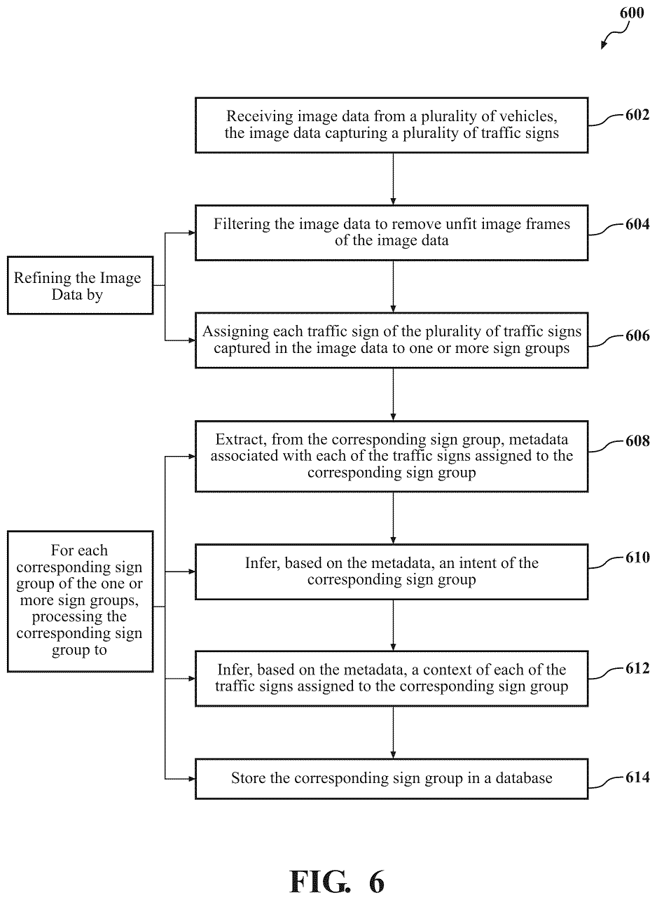

FIG. 6 includes a flowchart of an example arrangement of operations for a method 600 for detection of grouped traffic sign objects 510 for crowdsourcing. The method 600 may be described with reference to FIGS. 1-5C. Data processing hardware (e.g., data processing hardware 12, 62 of FIG. 1) may execute instructions stored on memory hardware (e.g., memory hardware 14, 64 of FIG. 1) to perform the example arrangement of operations for the method 600. At operation 602, the method 600 includes receiving image data 202 from a plurality of vehicles 10, the image data 202 capturing a plurality of traffic signs 510. At operation 604, the method 600 also includes refining the image data 202 to remove unfit image frames 204 of the image data 202, and, at operation 606, assigning each traffic sign 510 of the plurality of traffic signs 510 captured in the image data 202 to one or more sign groups 232.

For each corresponding sign group 232 of the one or more sign groups 232, the method 600 also includes, for operations 608-614, processing the corresponding sign group 232. In particular, at operation 608, the method 600 includes processing the corresponding sign group 232 to extract, from the corresponding sign group 232, metadata 234 associated with each of the traffic signs 510 assigned to the corresponding sign group 232. The method 600 also includes, at operation 610, processing the corresponding sign group 232 to infer, based on the metadata 234, an intent 242 of the corresponding sign group 232. At operation 612, the method 600 further includes processing the corresponding sign group 232 to infer, based on the metadata 232, a context 244 of each of the traffic signs 510 assigned to the corresponding sign group 232. At operation 614, the method 600 also includes processing the corresponding sign group 232 to store the corresponding sign group 232 in a datastore 250.

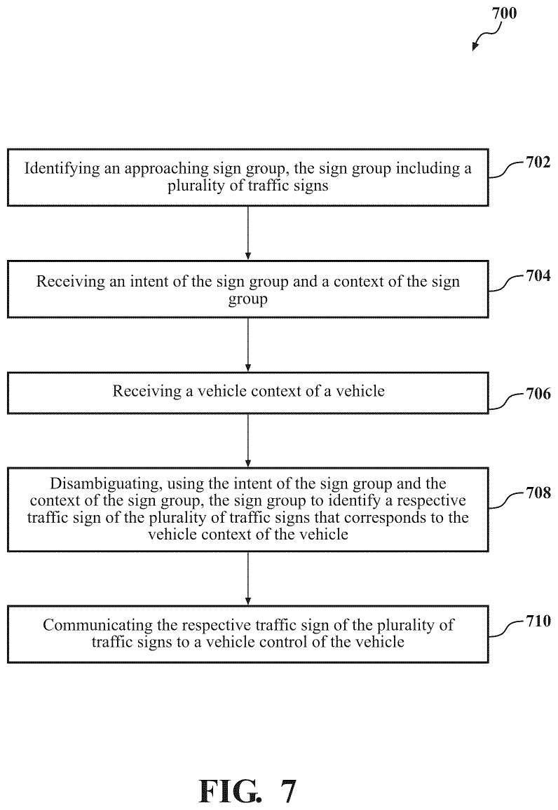

FIG. 7 includes a flowchart of an example arrangement of operations for a method 700 for detection of grouped traffic sign objects 510 for crowdsourcing. The method 700 may be described with reference to FIGS. 1-5C. Data processing hardware (e.g., data processing hardware 12, 62 of FIG. 1) may execute instructions stored on memory hardware (e.g., memory hardware 14, 64 of FIG. 1) to perform the example arrangement of operations for the method 700. At operation 702, the method 700 includes identifying an approaching sign group 232. Here, the sign group 232 includes a plurality of traffic signs 510. The method 700 also includes, at operation 704, receiving an intent 242 of the sign group 232 and a context 244 of the sign group 232.

At operation 706, the method 700 further includes receiving a vehicle context 24 of a vehicle 10. The method 700 also includes, at operation 708, disambiguating, using the intent 242 of the sign group 232 and the context 244 of the sign group 232, the sign group 232 to identify a respective traffic sign 510 of the plurality of traffic signs 510 that corresponds to the vehicle context 24 of the vehicle 10. The method 700 further includes, at operation 710, communicating the respective traffic sign 510 of the plurality of traffic signs 510 to a vehicle control of the vehicle 10.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method executed on data processing hardware that causes the data processing hardware to perform operations comprising:
receiving image data from a plurality of vehicles, the image data capturing a plurality of traffic signs;
refining the image data by:
filtering the image data to remove unfit image frames of the image data; and
assigning each traffic sign of the plurality of traffic signs captured in the image data to one or more sign groups; and
for each corresponding sign group of the one or more sign groups, processing the corresponding sign group to:
extract, from the corresponding sign group, metadata associated with each of the traffic signs assigned to the corresponding sign group;
infer, based on the metadata, an intent of the corresponding sign group;
infer, based on the metadata, a context of each of the traffic signs assigned to the corresponding sign group; and
store the corresponding sign group in a datastore.

2. The method of claim 1, wherein each of the traffic signs assigned to the corresponding sign group are located in proximity to one another.

3. The method of claim 1, wherein the received image data is captured over two or more days.

4. The method of claim 1, wherein filtering the image data further comprises:
identifying a plurality of image frames in the image data that capture duplicate traffic signs; and
fusing the duplicate traffic signs captured in the identified image frames.

5. The method of claim 1, wherein the metadata comprises one or more of:
semantic data;
color data;
positioning;
location;
dimension;
elevation; and
shape.

6. The method of claim 1, wherein the datastore comprises a lookup table.

7. The method of claim 1, wherein processing each of the corresponding sign group further comprises identifying, based on the metadata, a dependency of the corresponding sign group.

8. The method of claim 7, wherein the dependency includes one of independent or supplemental.

9. The method of claim 1, wherein the intent of the corresponding sign group comprises one of:
information;
enforcement; or
caution.

10. The method of claim 1, wherein the context of the corresponding sign group comprises one or more of:
vehicle type;
time of day;
vehicle location; and
environment.

11. A system comprising:
data processing hardware; and
memory hardware in communication with the data processing hardware, the memory hardware storing instructions that when executed on the data processing hardware cause the data processing hardware to perform operations comprising:
receiving image data from a plurality of vehicles, the image data capturing a plurality of traffic signs;
refining the image data by:
filtering the image data to remove unfit image frames of the image data; and
assigning each traffic sign of the plurality of traffic signs captured in the image data to one or more sign groups; and
for each corresponding sign group of the one or more sign groups, processing the corresponding sign group to:
extract, from the corresponding sign group, metadata associated with each of the traffic signs assigned to the corresponding sign group;
infer, based on the metadata, an intent of the corresponding sign group;
infer, based on the metadata, a context of each of the traffic signs assigned to the corresponding sign group; and
store the corresponding sign group in a datastore.

12. The system of claim 11, wherein each of the traffic signs assigned to the corresponding sign group are located in proximity to one another.

13. The system of claim 11, wherein the received image data is captured over two or more days.

14. The system of claim 11, wherein filtering the image data further comprises:
identifying a plurality of image frames in the image data that capture duplicate traffic signs; and
fusing the duplicate traffic signs captured in the identified image frames.

15. The system of claim 11, wherein the metadata comprises one or more of:
semantic data;
color data;
positioning;
location;
dimension;
elevation; and
shape.

16. The system of claim 11, wherein the datastore comprises a lookup table.

17. The system of claim 11, wherein processing each of the corresponding sign group further comprises identifying, based on the metadata, a dependency of the corresponding sign group.

18. The system of claim 11, wherein the intent of the corresponding sign group comprises one of:
information;
enforcement; or
caution.

19. The system of claim 11, wherein the context of the corresponding sign group comprises one or more of:
vehicle type;
time of day;
vehicle location; and
environment.

20. A computer-implemented method executed on data processing hardware that causes the data processing hardware to perform operations comprising:
identifying an approaching sign group, the sign group including a plurality of traffic signs;
receiving an intent of the sign group and a context of the sign group;
receiving a vehicle context of a vehicle;
disambiguating, using the intent of the sign group and the context of the sign group, the sign group to identify a respective traffic sign of the plurality of traffic signs that corresponds to the vehicle context of the vehicle; and
communicating the respective traffic sign of the plurality of traffic signs to a vehicle control of the vehicle.
